(19) United States
(12) Patent Application Publication
(10) Pub. No.: US 2013/0080283 A1
(43) Pub. Date: Mar. 28, 2013

(54) METHOD AND APPARATUS FOR PROVIDING STATUS OF INVENTORY

(71) Applicant: Allen Lee HOGAN, York, PA (US)

(72) Inventor: Allen Lee HOGAN, York, PA (US)

(21) Appl. No.: 13/680,867

(22) Filed: Nov. 19, 2012

Related U.S. Application Data
(63) Continuation of application No. 12/315,711, filed on Dec. 5, 2008, now abandoned.
(60) Provisional application No. 61/007,013, filed on Dec. 8, 2007.

(51) Int. Cl. G06Q 30/08

(52) U.S. Cl. CPC G06Q 30/0643; G06Q 30/08
USPC 705/26.3; 705/27.2

(57) ABSTRACT

A stateless e-commerce status indication system is provided. The system includes software code executable on at least one host website. The software code communicates with a remote processing server to obtain status information relating to status of an item for sale. The software then communicates at least a portion of the status information to a user of the host website.

### CROSS REFERENCE TO RELATED APPLICATIONS

This application is a continuation of application Ser. No. 12/315,711, filed Dec. 5, 2008, entitled METHOD AND APPARATUS FOR PROVIDING STATUS OF INVENTORY, which claims the benefit of U.S. Provisional Application No. 61/007,013, filed on Dec. 8, 2007, entitled APPARATUS AND METHOD COMMUNICATING THE STATUS OF AN ITEM FOR SALE, both of which Applications are herein incorporated by reference in their entirety.

### BACKGROUND OF THE INVENTION

The present invention relates to the field of Internet sales and, in particular, the communication of status information over the Internet. The present invention also relates to a method and apparatus for creating a computerized market for both tangible and/or non-tangible goods and/or services by use of the Internet to sell goods and/or services via one or multiple domain names whereby the sales status is communicated through a dynamically generated graphic.

It is believed that prior art methods and apparatuses of Internet sales and inventory tracking systems permit the status of an item for sale (e.g., whether the item has been sold or not) to be communicated to potential buyers only via the website (or domain) listing the item for sale. For example, an item for sale on Ebay may be listed on Ebay's website as “sold out” if the item has already been sold or is otherwise no longer available. If the item for sale is advertised on a domain different than the one listing the item for sale, a potential buyer visiting the different domain may not know whether the advertised item is still available for sale on the listing website, nor could the seller prevent a sale of a “sold out” item on the different domain, unless the status of the item on the different domain is updated manually or in a non-simultaneous fashion. This process becomes very difficult if the item is advertised on numerous different domains.

Referring to FIG. 1, there is illustrated a prior art method 100 for advertising a sale of an item across multiple domains. A seller advertises an item for sale on three websites 101, 105, 110 (e.g., Myspace, Craig's list and a Blogger page). A first buyer 145 visits website 101 and purchases the item by clicking on, for example, a “Buy” button/graphic 130, upon which website 101 notifies buyer 145 of the sale via a sale banner 115. The item is then shipped to buyer 145. Before the seller removes the sale advertisement from websites 105 and 110, second and third buyers 150, 155 visit websites 105, 110 to purchase the already sold item. Buyers 150, 155 click on their respective “Buy” buttons/graphics 135, 140 and receive respective “sold” notifications 120, 125, even though the item has already been sold to first buyer 145. This would require the seller to notify buyers 150, 155 that their sales were not consummated, which may result in disgruntled and/or unhappy buyers 150, 155.

### SUMMARY OF THE INVENTION

The present invention permits the status of an item for sale to be updated automatically across multiple domains that advertise the item. In this manner, the present invention provides for a stateless electronic e-commerce interface that can be placed on web pages to communicate the status of an item for sale.

In other words, the present invention relates to providing a means for anybody on the Internet to know the status of a sale at any time from any web page or web transaction such as email, forum, blog, classified ad, or press release. The present invention creates a stateless electronic commerce interface that can be placed on web pages across the Internet to communicate the status of a sale of an item or items to all parties involved simultaneously.

Regardless of the domain name, communicating the status of a sale is stateless meaning that if one web page communicating a sale's status becomes unreachable, the communication of that sale can still be obtained concurrently from other web pages or domain names promoting the sale. To further illustrate, if the domain name eBay.com becomes unavailable, the communication of a sale's status cannot take place. Whereas, with this invention, if one of multiple web pages or one of multiple domain names communicating a sale's status becomes unavailable, the communication of the sale's status can still be obtained from another web page or domain name. This is because the storage of data and processing occurs on a different domain name other than the domain name communicating the status of the sale.

In accordance with one embodiment of the present invention, a stateless e-commerce status indication system is provided. The system includes software code executable on at least one host website. The software code communicates with a remote processing server to obtain status information relating to status of an item for sale. The software code then communicates at least a portion of the status information to a user of the host website.

In accordance with another embodiment of the present invention, the software code includes a script executable by a web browser.

In accordance with still another embodiment of the present invention, the status information includes at least one of information relating to availability of the item, information relating to whether the item is still for sale, information relating to whether a sale of the item has expired, a description of the item, a quantity of the item, trust metrics for a seller, and a price of the item.

In accordance with still another embodiment of the present invention, the status information includes information relating to an auction.

In accordance with yet another embodiment of the present invention, the information relating to the auction includes at least one of a reserve price, a bid price, and an expiration date of the auction.

In accordance with still another embodiment of the present invention, the status information is communicated to the user via a graphic.

In accordance with another embodiment of the present invention, the graphic relates to the status information obtained from the remote processing server.

In accordance with yet another embodiment of the present invention, the graphic indicates that the item is unavailable for sale if the item was previously sold.

In accordance with another embodiment of the present invention, the graphic advertises a different product if the item was previously sold.

Without this invention, there is not a method to keep multiple buyers across multiple domains informed of the status of the sale. With this invention, the web page advertising the sale communicates whether the sale of the item is available or not based on the number of items that have been purchased or the expiration of the sale. One benefit of this invention to the seller is not being restricted to transact a sale with one domain name like eBay.com. A blogger, for instance, can now communicate the status of a sale for their motorcycle from their web page and/or get their community of readers (regardless of domain name) to also communicate the status of the sale for that motorcycle. Therefore, a seller or multiple sellers can now simultaneously communicate the status of a sale for the same item from one or multiple domain names.

### BRIEF DESCRIPTION OF THE DRAWINGS

FIG. 1 is an illustration of a prior art method for advertising a sale of an item across multiple domains.

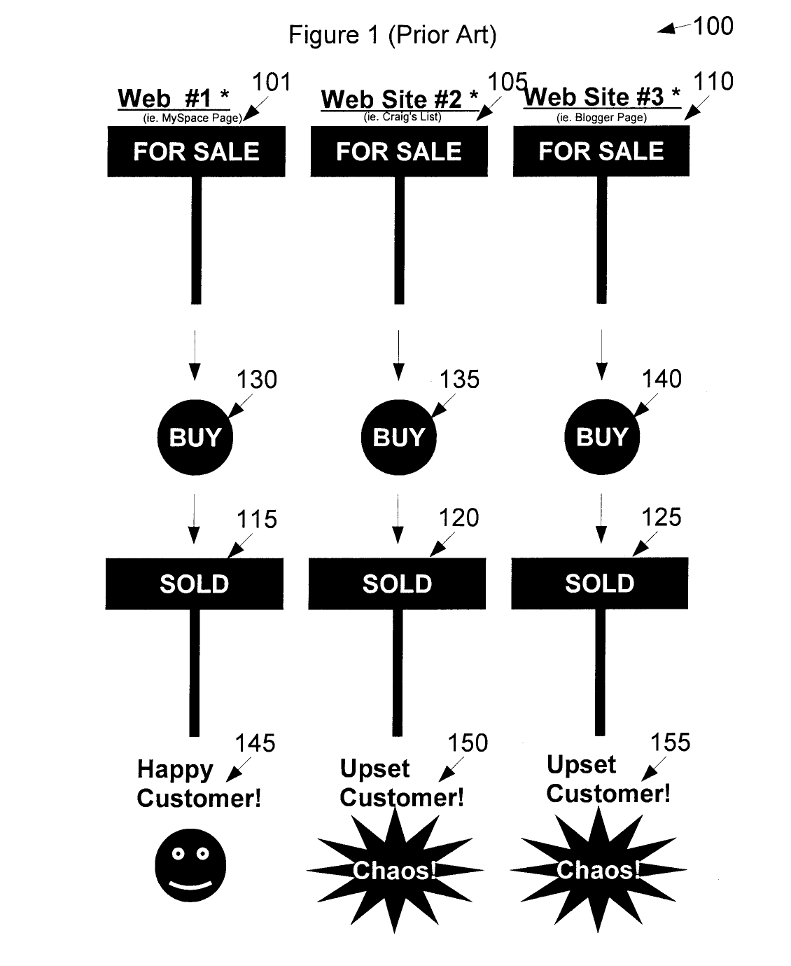

FIG. 2 is an illustration of a first stateless status and inventory control indicator system according to the present invention.

FIG. 3 is a flow diagram depicting a process for updating status information according to the present invention.

FIG. 4 is an illustration of a process for updating status information according to the present invention.

### DETAILED DESCRIPTION

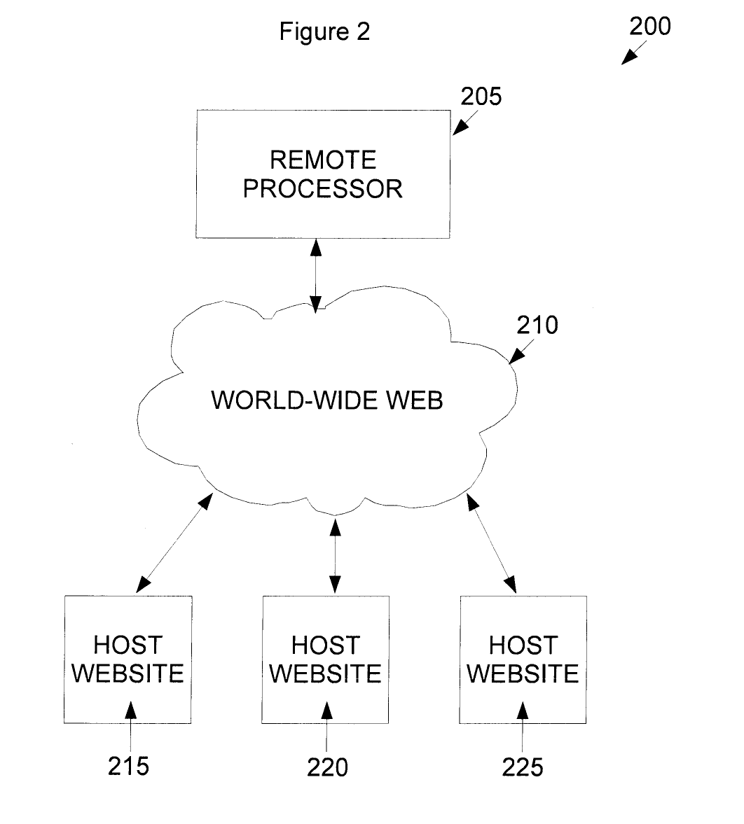

Referring now to FIG. 2, there is seen a first stateless status and inventory control indicator system 200 according to the present invention. Indicator system 200 includes a remote processor 205, a computer network (e.g., the Internet, world wide web, Intranet, etc.) 210 coupled to remote processor 205, and a plurality of host websites 215, 220, and 225 coupled to the computer network 210.

Remote processor 205 is a centralized location, such as a domain/website, that includes all particulars about the status of an item for sale. Such particulars may include, for example, information about the availability of an item, whether the item is still for sale, whether the sale has expired, a description of the item, quantity of the item available, trust metrics for the seller, the price of the item, etc. If the item is for sale at auction, the remote processor 205 may also include, for example, information relating to the auction, such as reserve price, bid price and expiration date of the auction. It will be appreciated by those having ordinary skill in the art that remote processor 205 may be resident at the domain/website listing the item for sale or may be a separate website.

Host websites 215, 220, 225 contain advertisements for the item for sale on the listing domain. In accordance with an example embodiment of the present invention, a programming script (which may be created automatically by remote processor 205 itself) is placed on each of host websites 215, 220, 225 for displaying status information (e.g., a graphic, such as a GIF file or icon) concerning the item for sale. The script permits users' browsers to communicate with remote processor 205 and retrieve therefrom particulars about the item for sale. Based on the information retrieved, the status information is then dynamically updated, e.g., upon each browser refresh, and displayed to the user accordingly. In one embodiment the status information consists of a graphic which may be stored on (and retrieved from) remote processor 205. It should be appreciated, however, that the status information graphic may be created or otherwise embedded within the script itself.

By running the inventive script on host websites 215, 220, 225, the status of the item for sale may be updated automatically and simultaneously to buyers of all websites 215, 220, 225, thereby preventing subsequent buyers from purchasing an unavailable item. The script also permits simultaneous bids across multiple domain names for auctioned items. This permits the seller to offer an item for sale across multiple domains at the same time without the need for manual updating of status information on these domains.

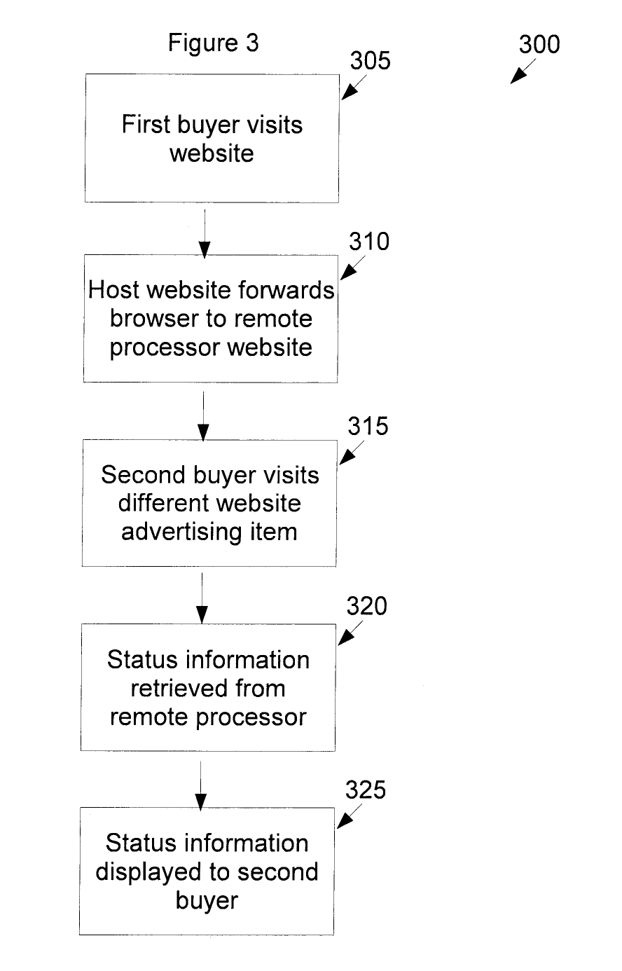

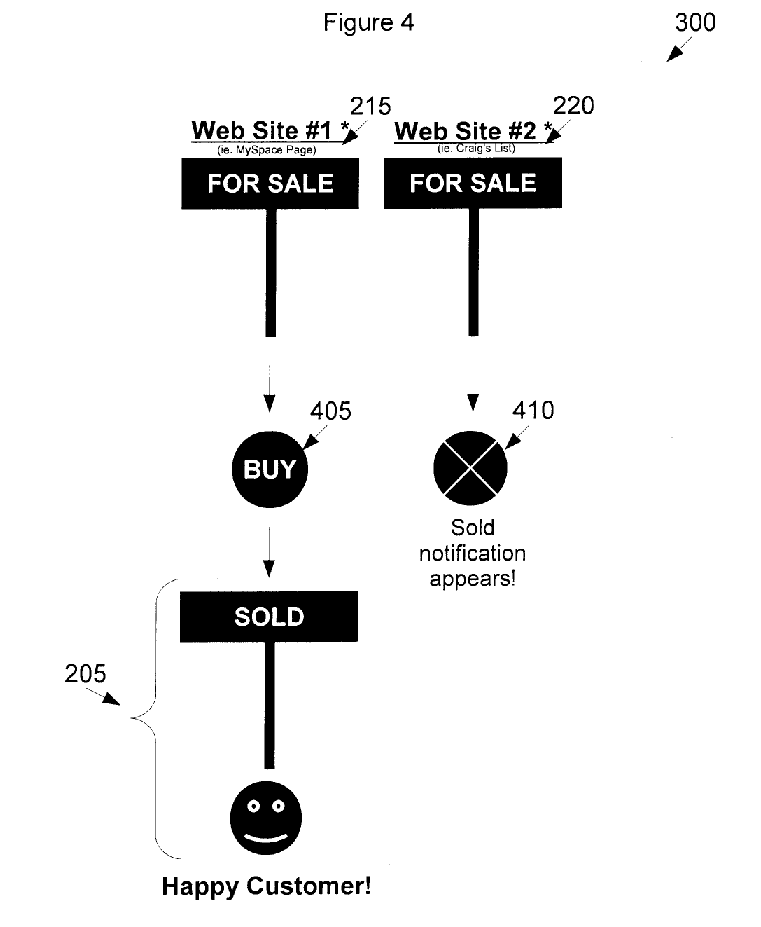

Referring now to FIGS. 3 and 4, there is seen a process 300 for updating status information according to the present invention. At step 305, a first buyer visits website 215, where the script displays a first graphic 405 indicating that the item is for sale. To display the graphic, the script retrieves status information from remote processor 205, which may include, for example, a first graphic 405. At step 310, the host website forwards the user's browser to the website of the remote processor 205, where the sale is consummated. In one embodiment, the seller is automatically notified of the sale by e-mail. At step 315, a second buyer visits website 220. At step 320, the browser of the second buyer interprets the script, which then retrieves the status information from the website of the remote processor 205 and displays it at step 325. Since the item for sale was already sold to the first buyer, the status information retrieved from remote processor 205 indicates that the item was sold, for example, via a second graphic 410. In this manner, the second buyer is notified that the item is no longer for sale immediately upon visiting website 220. In an alternative embodiment, the script causes another item to be advertised on host website 220 if the original item is sold.

One embodiment of the invention relates to a method termed ‘Stateless E-Commerce Status Communicator’. A seller can now communicate the status of a sale across multiple domain names. For the remaining of this document, ‘host’ refers to the web page that contains the script used for communicating the sale and ‘remote processor’ refers to the domain name containing the software used to process and store the data for retrieval.

Process #1: The sale is communicated through a programming script that is placed on the host website that wants to advertise the sale. The script is a placeholder for the communication process. The script, when processed, turns into a graphic that is updated upon browser refresh. When the status of the sale has changed, the graphic is dynamically changed via the remote processor. Therefore, the communication of the sale occurs through an image on the host site that is updated dynamically upon retrieval from the remote processor. As a result of this process: 1) potential buyers can be simultaneously notified of the status of the sale; 2) simultaneous updates of the status of the sale can occur across multiple domain names; and 3) the status of the sale can communicate anything pertaining to the sale such as description, purchase price, bid price, reserve price, quantity available. trust metrics of the seller, expiration of the sale, etc. The benefit therefore is a process of buying and selling that creates an opportunity for the seller to sell or auction items across multiple domain names at the same time.

Process #2: The sale is communicated through a programming script that is placed on the host website that wants to advertise the sale. The script is a placeholder for the communication process. The script, when processed, communicates the status of the sale. If the number of items for sale have been sold, the host will display a new graphic that communicates the unavailability of the item for the sale. However, if the number of items for the sale have not been sold, the graphic communicating the sale continues to be shown. The proper status of the sale can only be displayed when a finite number of items for the sale have been entered via the remote processor.

This communication process introduces a unique method of preventing subsequent buyers from purchasing an unavailable item via a remote processor. As a result of this process: 1) potential buyers are simultaneously notified of the status of the sale of the inventoried item(s) upon browser refresh; potential buyers are prevented from purchasing an unavailable item; and sellers can now sale their finite number of item(s) across one or multiple domain names. Unavailable items display an image communicating the unavailability of the item. Available items display an image communicating the availability of the item. As a result of combining process #1 and process #2, sellers can also include an expiration date of the sale to be communicated. Without process #1, if the time would expire for an item for sale, the buyer could not be notified of the expiration. Without process #2, if the item sold before the expiration, subsequent buyers would be allowed to continue with the purchase of an unavailable item. Subsequently, when the sale actually does expire, buyers would be notified incorrectly that the item for sale has expired.

In one embodiment, if a graphic is updated dynamically, the host must be refreshed to see the new image. However, even if a potential buyer clicks on a graphic within a browser that was not refreshed, the sale of the item is still communicated appropriately because the purchase or bidding process must go through the remote processor. At this point in time, the buyer would be properly updated of the details of the sale before a bid or purchase could take place. After the item for sale has either been sold or expired, a new graphic can be displayed in the form of an advertisement or sale of another item from a different seller fulfilling the proper communication of the previous items unavailability. Displaying the words ‘Sold’ do not necessarily have to take place. The prevention comes from a new sale in the form of a new graphic taking the place of the old graphic.

In another embodiment, in order for a programming script to be created, the details of the sale have to be entered and processed by the remote processor. Therefore, the selling process begins at the remote processor's website. After the programming script has been created, the seller places the script on a web page. The host browser then interprets the script and retrieves the necessary graphic from the remote processor. The graphic display is used to communicate the sale.

If the sale is an auction, the graphic displays the necessary information related to the auction. The buyer clicks on the graphic when they want to proceed with an action required and communicated via the graphic such as a bid or purchase. The programming script then forwards the buyer to the remote processor's website where the necessary action communicated via the graphic can proceed. If a bid is necessary, the buyer places their offer on the remote processor's website which then dynamically updates the graphic. Upon return to the host website that is advertising the sale, the browser interprets the original script but the graphic image from the remote processor now communicates a new offer. During the process of the sale, if the terms of the auction are met such as reserve price and expiration, an updated graphic is dynamically created via the remote processor. Subsequently, the displayed image on the host site communicates the end of the auction accordingly. Communication of the auction ending occurs across multiple domain names if in fact the sale is being advertised across multiple domain names.

If the sale is a classified ad, the graphic displays the necessary information related to the sale. The buyer clicks on the graphic when they want to proceed to purchase the item. The programming script then forwards the buyer to the remote processor's website where the buyer can now purchase the item for sale. Once the purchase is complete, the graphic is dynamically updated. The host website(s) now displays a graphic indicating the item has sold.

In one embodiment the method can be summarized as follows: Remote Processor—Seller enters sales data; Remote Processor—proprietary software creates script for seller to copy; Host Website—Seller pastes script on host site; Host Website—Successful interpretation of script reveals item for sale; Host Website—Buyer clicks on item to purchase and then is transferred to Remote Processor; Remote Processor—Buyer places bid or purchases item for sale; Remote Processor—Transaction of bid or purchase is completed and the database updated accordingly; and Host Website—Host displays sales status update image. Upon completion of the sale, the seller is automatically notified via email.

In one exemplary embodiment, every time the image is refreshed from client's browser, this code is executed: connect to database; perform SQL execution to pull image variables; if image exists then populate image variables; if variables say launch date>now then use launch image (prevent user from buying soon to be advertised item(s)); if variables say sold, show sold image (prevent user from buying advertised item); if variables say expired, show expired image (prevent user from buying advertised item); and if variables say the current conditions of the advertised product/service were met in terms of being sold or expired (based on image variables) but is one that is allowed to change then change the image to a new one that is similar in category (this strategy also prevents user from buying advertised item). Upload picture of product selling and embed into image as a thumbnail. Based on database image variables, dynamically change current image with real time results in time left before ad expires and quantity left in inventory and other information such as description, cost, price, color, feedback, etc.

What is claimed is:

1. A method of updating a status of an item for sale over the Internet, the method comprising:
storing status information relating to an item for sale on a remote server;
generating an image at the remote server, the generated image having incorporated therein status information relating to the item for sale;
placing a programming script executable by a web browser on a plurality of web pages to offer the item for sale; and
executing the programming script on each webpage of the plurality of web pages with a corresponding web browser, said executing the programming script comprising:
retrieving the generated image from the remote server over the Internet in response to a user accessing the web page with a web browser;
displaying the retrieved image on the web page, the retrieved image includes therein the incorporated status information from the remote server relating to the item for sale.

2. The method of claim 1 wherein said storing status information relating to an item for sale comprises storing information on the remote server relating to at least one of item availability, item sale time, item description, item quantity, item price or trust metrics for a seller.

3. The method of claim 2 wherein the status information incorporated in the generated image indicates that the item for sale is unavailable in response to a prior sale of the item for sale or an expiration of a sale time for the item for sale.

4. The method of claim 1 wherein said generating an image at the remote server comprises changing the status information incorporated in the generated image in response to a sale of the item for sale.

5. The method of claim 1 wherein said generating an image at the remote server comprises generating a second image having incorporated therein status information relating to a different item for sale in response to a sale of the item for sale or an expiration of a sale time for the item for sale.

6. The method of claim 1 further comprises repeating said retrieving the generated image from the remote server and said displaying the retrieved image upon each refresh of the web browser.

7. The method of claim 1 further comprising forwarding the web browser of the user to a website for the remote server in response to the user wanting to purchase the item for sale.

8. The method of claim 7 wherein said executing the programming script further comprises:
retrieving the generated image from the remote server over the Internet in response to a second user accessing a second webpage of the plurality of web pages with a web browser; and
displaying the retrieved image on the second webpage, wherein the retrieved image includes therein the incorporated status information indicating the item for sale is unavailable in response to the user purchasing the item for sale.

9. The method of claim 1 wherein said storing status information relating to an item for sale comprises storing status information on the remote server relating to an auction.

10. The method of claim 9 wherein said storing status information on the remote server relating to an auction comprises storing status information on the remote server relating to at least one of a reserve price, a bid price, and an expiration date of the auction.

11. A system comprising:
a remote processor storing status information on an item for sale, the remote processor being operable to generate an image having incorporated therein status information on the item for sale;
a plurality of websites having different domains, each website of the plurality of websites having a webpage identifying the item for sale;
a computer network communicatively coupling the remote processor and the plurality of websites;
an interface placed on the webpage of each website of the plurality of websites, the interface comprising a programming script to automatically retrieve the image with the incorporated status information from the remote processor and to display the retrieved image with the incorporated status information on the item for sale when the programming script is executed by a web browser.

12. The system of claim 11 wherein the programming script is executable by a web browser.

13. The system of claim 11 wherein the retrieved image with the incorporated status information includes information relating to at least one of item availability, item sale time, item description, item quantity, item price or trust metrics for a seller.

14. The system of claim 13 wherein the retrieved image with the incorporated status information includes information that the item for sale is unavailable in response to a prior sale of the item for sale or an expiration of a sale time for the item for sale.

15. The system of claim 11 wherein the retrieved image with the incorporated status information includes information relating to an auction.

16. The system of claim 15 wherein the information relating to the auction includes at least one of a reserve price, a bid price, and an expiration date of the auction.

17. The system of claim 11 wherein the image with the incorporated status information retrieved from the remote processor is dynamically updated upon each refresh of the web browser.

18. The system of claim 11 wherein the retrieved image with the incorporated status information includes information to advertise a different item for sale in response to a sale of the item for sale or an expiration of a sale time for the item for sale.

19. The system of claim 11 wherein the remote processor comprises a website of the plurality of websites.

20. The system of claim 11 wherein the remote processor automatically creates the interface.
